(19) United States
(12) Patent Application Publication
(10) Pub. No.: US 2016/0200909 A1
(43) Pub. Date: Jul. 14, 2016

(54) A Composition, Articles Made Therefrom, and Method of Making the Articles

(71) Applicant: DOW GLOBAL TECHNOLOGIES LLC, Midland, MI (US)

(72) Inventors: Dane Chang, Freeport, TX (US); Carl F. Baker, Freeport, TX (US); Zhiqiang Zhou, Freeport, TX (US); Suzanne G. Guerra, Freeport, TX (US); Jeffrey M. Cogen, Collegeville, PA (US); Bharat I. Chaudhary, Collegeville, PA (US); Mohamed Esseghir, Collegeville, PA (US); Saurav S. Sengupta, Midland, MI (US)

(21) Appl. No.: 14/653,372

(22) PCT Filed: Nov. 19, 2013
(86) PCT No.: PCT/US2013/070714

§ 371 Date: Jun. 18, 2015

Related U.S. Application Data
(60) Provisional application No. 61/747,609, filed on Dec. 31, 2012.

(51) Int. Cl. C08L 51/00

(52) U.S. Cl. CPC C08L 51/003

(57) ABSTRACT

A crosslinked polyethylene composition formed through reaction of (A) functionalized polyethlyene having vinyltrialkoxysilanol grafted functionalities; and (B) hydroxyl-terminated silicone, wherein the crosslinked polyethylene comprises —C—C—Si—[O—Si(C)₂]ₘ—O—Si—C—C— crosslinkages is provided; and (C) a small amount of catalyst. Articles made from the crosslinked polyethtylene and methods of making such articles are also provided.

### FIELD OF INVENTION

The instant invention relates to a composition, articles made therefrom, and a method of making the articles.

### BACKGROUND OF THE INVENTION

Crossed-linked polyethylene (PEX) is used for a number of end use application with PEX pipe being one of the most common uses. PEX pipe exhibits higher temperature resistance, is particularly suited to hot and cold water plumbing applications. The cross-linkages in PEX-b pipe are formed through silanol condensation between two grafted vinyltrimethoxysilane functionalities on polyethylene, thereby connecting the polyethylene chains. Partially crosslinked polyethylene results in higher molecular weight and, thus, higher viscosity and melt strength for thicker wall pipe. The complexity and cost of producing PEX-b pipe arises from the need for post extrusion moisture activated cross-linking at elevated temperature which, under some conditions, may require up to a few days of exposure to heat and humidity.

### SUMMARY OF THE INVENTION

The instant invention is a composition, articles made therefrom, and a method of making the articles.

In one embodiment, the instant invention provides a crosslinked polyethylene composition formed through reaction of (A) functionalized polyethlyene having vinyltrialkoxysilanol grafted functionalities; and (B) hydroxyl-terminated silicone, wherein the crosslinked polyethylene comprises C—C—Si—[O—Si(C)₂]ₘ—O—Si—C—C crosslinkages; and (C) a small amount of catalyst

### DETAILED DESCRIPTION OF THE INVENTION

The instant invention is a composition, articles made therefrom, and methods for making the articles.

The composition according to the present invention is a crosslinked polyethylene composition formed through reaction of (A) functionalized polyethlyene having vinyltrialkoxysilanol grafted functionalities; and (B) one or more hydroxyl-terminated silicones, wherein the crosslinked polyethylene comprises —C—C—Si—[O—Si(C)₂]ₘ—O—Si—C—C— crosslinkages; and (C) a small amount of catalyst.

In an alternative embodiment, the instant invention further provides a process for preparing a crosslinked polyethylene resin comprising providing a polyethylene having vinyltrialkoxysilanol grafted functionalities; and mixing the polyethylene with one or more hydroxyl-terminated silicones, to form a crosslinkable mixture; wherein the crosslinkable mixture is capable of forming —C—C—Si—[O—Si(C)₂]ₘ—O—Si—C—C— crosslinkages at a temperature less than 70° C.

In another alternative embodiment, the instant invention further provides an article comprising the crosslinked polyethylene according to any one of the embodiments disclosed herein.

In yet another alternative embodiment, the instant invention further provides a process for making an article comprising transforming a crosslinked polyethylene composition according to any one of the embodiments disclosed herein by one or more processing techniques selected from the group consisting of injection molding, extrusion, compression molding, rotational molding, thermoforming, blowmolding, powder coating, Banbury batch mixers, fiber spinning, and calendaring.

Exemplary vinyltrialkoxysilanol functionalities suitable for use in embodiments of the invention include vinyltrimethoxysilanol, vinyltriethoxysilanol, vinyltripropoxysilanol, vinyltripentoxysilanol and combinations of two or more thereof.

The crosslinked polyethylene comprises —C—C—Si—[O—Si(C)₂]ₘ—O—Si—C—C— crosslinkages, wherein m is any integer 1 or greater. All individual values and subranges are included herein and disclosed herein; for example, the value of m may be any integer equal to or greater than 1, or in the alternative, the value of m may be any integer equal to or greater than 2, or in the alternative, the value of m may be any integer equal to or greater than 3, or in the alternative, the value of m may be any integer equal to or greater than 4, or in the alternative, the value of m may be any integer equal to or greater than 5.

The one or more hydroxyl-terminated silicones useful in embodiments of the invention generally have the formula:

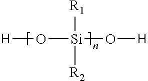

where R₁ and R₂ are alkyl groups with at least one carbon. n is any integer having a value of at least 1. All individual values and subranges are included herein and disclosed herein; for example, the value of n may be any integer equal to or greater than 1, or in the alternative, the value of n may be any integer equal to or greater than 2, or in the alternative, the value of n may be any integer equal to or greater than 3, or in the alternative, the value of n may be any integer equal to or greater than 4, or in the alternative, the value of n may be any integer equal to or greater than 5.

The crosslinkable mixture is capable of forming —C—C—Si—[O—Si(C)₂]m—O—Si—C—C— crosslinkages at a temperature less than or equal to 70° C. All individual values and subranges from temperatures less than or equal to 70° C. are included herein and disclosed herein. For example, the crosslinkable mixture may be capable of forming the crosslinkages at a temperature less than or equal to 70° C., or in the alternative, the crosslinkable mixture may be capable of forming the crosslinkages at a temperature less than or equal to 60° C., or in the alternative, the crosslinkable mixture may be capable of forming the crosslinkages at a temperature less than or equal to 50° C., or in the alternative, the crosslinkable mixture may be capable of forming the crosslinkages at a temperature less than or equal to 40° C., or in the alternative, the crosslinkable mixture may be capable of forming the crosslinkages at a temperature less than or equal to 30° C.

In an alternative embodiment, the instant invention provides a composition, method of producing the same, articles made therefrom, and method of making such articles, in accordance with any of the preceding embodiments, except that the crosslinkable mixture is capable of forming C—C—Si—[O—Si(C)₂]ₘ—O—Si—C—C crosslinkages at a temperature from 10 to 70° C. All individual values and subranges from 10 to 70° C. are included herein and disclosed herein. For example, the crosslinkable mixture is capable of forming C—C—Si—[O—Si(C)₂]ₘ—O—Si—C—C crosslinkages at a temperature from 10 to 70° C., or in the alternative, from 10 to 50° C., or in the alternative, from 15 to 30° C., or in the alternative, from 25 to 35° C., or in the alternative, from 10 to 50° C., or in the alternative, from 20 to 50° C., or in the alternative, from 20 to 30° C.

In an alternative embodiment, the instant invention provides a composition, method of producing the same, articles made therefrom, and method of making such articles, in accordance with any of the embodiments disclosed herein, except that the polyethylene is mixed with 50 ppm to 20 wt % hydroxyl-terminated silicone to form the crosslinked polyethylene. All individual values and subranges from 50 ppm to 20 percent by weight are included herein and disclosed herein; for example, the amount of hydroxyl-terminated silicone can be from a lower limit of 50, 100 ppm, 500 ppm, 0.1 wt %, 0.5 wt %, 1.5 wt %, 2.5 wt %, 3.5 wt % or 4.5 wt % to an upper limit of 100 ppm, 200 ppm, 600 ppm, 0.2 wt %, 0.5 wt %, 3.6 wt %, 5 wt %, 8.5 wt %, 15 wt %, 18 wt % or 20 wt %. For example, the amount of hydroxyl-terminated silicone can range from 50 ppm to 20 wt %, or in the alternative, the amount of hydroxyl-terminated silicone can range from 100 ppm to 10 wt %, or in the alternative, the amount of hydroxyl-terminated silicone can range from 1000 ppm to 5 wt %, or in the alternative, the amount of hydroxyl-terminated silicone can range from 100 ppm to 5 wt %.

In yet another embodiment, the instant invention provides a composition, method of producing the same, articles made therefrom, and method of making such articles, in accordance with any of the embodiments disclosed herein, except that the crosslinked polyethylene has a viscosity at 190° C. of at least 10⁷ Pa s. For example, the crosslinked polyethylene can have a viscosity at 190° C. of at least 10⁷ Pa s, or in the alternative, of at least 10⁸ Pa s, or in the alternative, of at least 10⁹ Pa s, or in the alternative, of at least 10¹⁰ Pa s.

Without wishing to be bound by any particular theory, it is believed that increasing the hydroxyl terminated silicone amount will result in an increased viscosity of the composition.

In yet another embodiment, the instant invention provides a composition, articles made therefrom, and method of making such articles, in accordance with any of the embodiments disclosed herein, except that the polyethylene is one or more selected from the group consisting of low density polyethylene, high density polyethylene, linear low density polyethylene, and combinations thereof.

In yet another embodiment, the instant invention provides a composition, articles made therefrom, and method of making such articles, in accordance with any of the embodiments disclosed herein, except that the polyethylene is one or more selected from the group consisting of ethylene homopolymers, or ethylene/α-olefin interpolymers.

As used herein, the term “interpolymer” refers to polymers prepared by the polymerization of at least two different types of monomers. The generic term interpolymer thus includes copolymers, usually employed to refer to polymers prepared from two different types of monomers, and polymers prepared from more than two different types of monomers.

In yet another embodiment, the instant invention provides a composition, method of producing the same, articles made therefrom, and method of making such articles, in accordance with any of the embodiments disclosed herein, except that the polyethylene has a density of from 0.925 to 0.97 g/cm³. All individual values and subranges from 0.925 to 0.97 g/cm³ is included herein and disclosed herein; for example, the density of the polyethylene density may range from a lower limit of 0.925, 0.930, 0.930, 0.935, 0.940, 0.945, 0.950, 0.955, or 0.965 g/cm³ to an upper limit of 0.930, 0.930, 0.935, 0.940, 0.945, 0.950, 0.955, 0.960, or 0.97 g/cm³. For example, the density of the polyethylene density may be from 0.925 to 0.97 g/cm³, or in the alternative, the density of the polyethylene density may be from 0.940 to 0.950 g/cm³, or in the alternative, the density of the polyethylene density may be from 0.925 to 0.940 g/cm³, or in the alternative, the density of the polyethylene density may be from 0.925 to 0.935 g/cm³, or in the alternative, the density of the polyethylene density may be from 0.935 to 0.945 g/cm³.

In yet another embodiment, the instant invention provides a composition, method of producing the same, articles made therefrom, and method of making such articles, in accordance with any of the embodiments disclosed herein, except that the polyethylene has a an I₂ of from 0.001 to 100 g/10 minutes. All individual values and subranges from 0.001 to 100 g/10 minutes are included and disclosed herein; for example, the polyethylene I₂ may range from a lower limit of 0.001, 0.005, 0.01, 1, 2, 3, 4, 5, 10, 20, 50, or 90 g/10 minutes to an upper limit of 0.006, 0.05, 2, 5, 10, 50, or 100 g/10 minutes. For example, the I₂ of the polyethylene may range from 0.01 to 10 g/10 minutes, or in the alternative, the I₂ of the polyethylene may range from 0.01 to 5 g/10 minutes, or in the alternative, the I₂ of the polyethylene may range from 0.05 to 5 g/10 minutes, or in the alternative, the I₂ of the polyethylene may range from 1 to 10 g/10 minutes, or in the alternative, the I₂ of the polyethylene may range from 0.05 to 1 g/10 minutes.

In yet another embodiment, the instant invention provides a composition, method of producing the same, articles made therefrom, and method of making such articles, in accordance with any of the embodiments disclosed herein, except that the polyethylene is a high density polyethylene having a density equal to or greater than 0.940 to 0.97 g/cm³. All individual values and subranges from 0.940 to 0.97 g/cm³ are included herein and disclosed herein; for example, the high density polyethylene may have a density from a lower limit of 0.940, 0.945, 0.950, 0.955 or 0.965 g/cm³ to an upper limit of 0.945, 0.950, 0.955, 0.960, or 0.97 g/cm³. For example, the density may range from 0.940 to 0.97 g/cm³, or in the alternative, the density may range from 0.940 to 0.955 g/cm³, or in the alternative, the density may range from 0.945 to 0.950 g/cm³, or in the alternative, the density may range from 0.950 to 0.960 g/cm³.

The high density ethylene polymer component may be prepared by syntheses known in the art, including, but not limited to gas phase polymerizations using chromium-based catalyst systems

Ethylene/α-olefin interpolymers may be produced using any conventional ethylene/α-olefin polymerization technology generally known in the art. For example, polymerization of the ethylene/α olefin interpolymer may be accomplished at conditions well known in the art for Ziegler-Natta or Kaminsky-Sinn type polymerization reactions. The ethylene/α-olefin interpolymer may also be made using a mono- or bis-cyclopentadienyl, indenyl, or fluorenyl transition metal (preferably Group 4) catalysts or constrained geometry catalysts. Suspension, solution, slurry, gas phase, solid-state powder polymerization, or other process conditions may be employed if desired. A support, such as silica, alumina, or a polymer (such as polytetrafluoroethylene or a polyolefin) may also be employed if desired.

Ethylene may also be polymerized with at least one ethylenically unsaturated monomer, selected from the group consisting of C3-C12 alpha-olefins, C1-C12 alkyl esters of C3-C20 monocarboxylic acids; unsaturated C3-C20 mono- or dicarboxylic acids; anhydrides of unsaturated C4-C8 dicarboxylic acids; and vinyl esters of saturated C2-C18 carboxylic acids.

The polyethylene may be prepared by free radical processes, Ziegler-Natta catalyst systems, such as the improved methodology presented in U.S. Pat. Nos. 4,661,465 and 4,873,300, metallocene catalyst systems, and/or constrained geometry catalyst systems, such as those disclosed in U.S. Pat. Nos. 5,272,236 and 5,278,272; each incorporated herein, in its entirety, by reference.

The high-density polyethylene may include any amount of one or more α-olefin comonomers; for example, the high-density polyethylene may comprise about less than 15 percent by weight of one or more α-olefin comonomers, based on the weight of the high-density polyethylene. All individual values and subranges less than 15 weight percent are included herein and disclosed herein; for example, the weight percent of one or more α-olefin comonomers may be from a lower limit of 0, 1, 2, 3, 5, 7, 9, 12, or 14 weight percent to an upper limit of 5, 9, 10, 12, or 15 weight percent. For example, the high-density polyethylene may comprise about less than 10 percent by weight of one or more α-olefin comonomers, based on the weight of the high-density polyethylene; or in the alternative, the high-density polyethylene may comprise about less than 7 percent by weight of one or more α-olefin comonomers, based on the weight of the high-density polyethylene; in the alternative, the high-density polyethylene may comprise about less than 5 percent by weight of one or more α-olefin comonomers, based on the weight of the high-density polyethylene.

The high-density polyethylene may include any amount of ethylene; for example, the high-density polyethylene may comprise about at least 85 percent by weight of ethylene, based on the weight of the high-density polyethylene. All individual values and subranges equal or greater than 85 weight percent are included herein and disclosed herein; for example, the weight percent of ethylene may be from a lower limit of 85, 87, 88, 90, 91, 95, 98, or 99 weight percent to an upper limit of 90, 91, 93, 95, 98, or 100. For example, the high-density polyethylene may comprise at least 85 percent by weight of ethylene, based on the weight of the high-density polyethylene; or in the alternative, the high-density polyethylene may comprise at least 90 percent by weight of ethylene, based on the weight of the high-density polyethylene; in the alternative, the high-density polyethylene may comprise at least 95 percent by weight of ethylene, based on the weight of the high-density polyethylene.

The α-olefin comonomers typically have no more than 20 carbon atoms. For example, the α-olefin comonomers may preferably have 3 to 10 carbon atoms, and more preferably 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene. The α-olefin comonomers may preferably be selected from the group consisting of propylene, 1-butene, 1-hexene, and 1-octene, and more preferably from the group consisting of 1-hexene and 1-octene.

Any conventional ethylene homopolymerization or copolymerization reactions may be employed to produce the high-density polyethylene component of the instant invention. Such conventional ethylene homopolymerization or copolymerization reactions include, but are not limited to, gas phase polymerization, slurry phase polymerization, liquid phase polymerization, and combinations thereof using conventional reactors, e.g. gas phase reactors, loop reactors, stirred tank reactors, batch reactors, and combinations thereof in series or parallel.

In yet another embodiment, the instant invention provides a composition, articles made therefrom, and method of making such articles, in accordance with any of the embodiments disclosed herein, except that the high-density polyethylene has a melt index (I₂₁); for example, the high-density polyethylene composition may have a melt index (I₂₁) in the range of 0.1 to 200 g/10 minutes. All individual values and subranges from 0.1 to 200 g/10 minutes are included herein and disclosed herein; for example, the high-density polyethylene composition may have a melt index (I₂₁) in the range of 0.1 to 10 g/10 minutes, or in the alternative, the high-density polyethylene composition may have a melt index (I₂₁) in the range of 1 to 5 g/10 minutes, or in the alternative, the high-density polyethylene composition may have a melt index (I₂₁) in the range of 0.5 to 15 g/10 minutes.

In yet another embodiment, the instant invention provides a composition, articles made therefrom, and method of making such articles, in accordance with any of the embodiments disclosed herein, except that the high-density polyethylene has a molecular weight distribution in the range of 3 to 50. All individual values and subranges from 3 to 50 are included herein and disclosed herein; for example, the high-density polyethylene composition may have a molecular weight distribution with a lower limit from 3, 10, 20, 30, or 40 to an upper limit of 3, 15, 25, 35, 45 or 50. For example, the high density polyethylene may have a molecular weight distribution in the range of from 3 to 50, or in the alternative, the high density polyethylene may have a molecular weight distribution in the range of from 3 to 25, or in the alternative, the high density polyethylene may have a molecular weight distribution in the range of from 10 to 30, or in the alternative, the high density polyethylene may have a molecular weight distribution in the range of from 3 to 50, or in the alternative, in the range of 25 to 50. The term molecular weight distribution or “MWD,” as used herein, refers to the ratio of weight average molecular weight (Mw) to number average molecular weight (Mn), i.e. (Mw/Mn), described in further details herein below.

The crosslinked polyethylene composition may further include additional additives. Such additives include, but are not limited to, antistatic agents, color enhancers, dyes, lubricants, fillers, pigments, primary antioxidants, secondary antioxidants, processing aids, UV stabilizers, and combinations thereof. The crosslinked polyethylene composition may contain any amounts of additives. The crosslinked polyethylene composition may compromise from about 0 to about 2 percent by the combined weight of additives, based on the weight of the total polyethylene composition. All individual values and subranges from about 0 to about 2 weight percent are included herein and disclosed herein; for example, the total polyethylene composition may compromise from 0 to 0.8 percent by the combined weight of additives, based on the weight of the crosslinked polyethylene composition. Antioxidants, such as IRGANOX 1076 and IRGANOX 1010, are commonly used to protect the polymer from thermal and/or oxidative degradation. IRGANOX 1076 and IRGANOX 1010 are commercially available from BASF.

High-density polyethylene useful in the invention may be made according to any process known in the art.

In a preferred embodiment, the present invention is an article of manufacture prepared from the crosslinkable polymeric composition. Any number of processing techniques can be used to prepare the articles. Specifically useful processes include injection molding, extrusion, rotational molding, thermoforming, blowmolding, Banbury batch mixers, and calendaring.

Suitable articles of manufacture include wire-and-cable insulations, wire-and-cable semiconductive articles, wire-and-cable jackets, cable accessories, shoe soles, multicomponent shoe soles (including polymers of different densities and type), gaskets, profiles, durable goods, construction panels, composites (e.g., wood composites), pipes, foams, blown films, and fibers (including binder fibers and elastic fibers).

In a particular embodiment, the article of manufacture is a pipe having a wall thickness up to 20 cm. All individual values and subranges of up to 20 cm are included and disclosed herein. For example, the pipe may have a thickness up to 20 cm, or in the alternative, the pipe may have a thickness up to 15 cm, or in the alternative, the pipe may have a thickness up to 12 cm, or in the alternative, the pipe may have a thickness up to 10 cm.

In yet another embodiment, the instant invention provides a composition, method of producing the same, articles made therefrom, and method of making such articles, in accordance with any of the embodiments disclosed herein except that the a process for preparing a crosslinked polyethylene resin consists essentially of: providing a polyethylene having vinyltrialkoxysilanol grafted functionalities; and mixing the polyethylene with one or more hydroxyl-terminated silicones, and optionally a small amount of catalyst to form a crosslinkable mixture; wherein the crosslinkable mixture is capable of forming —C—C—Si—[O—Si(C)₂]ₘ—O—Si—C—C— crosslinkages at a temperature less than 70° C.

In yet another embodiment, the instant invention provides a composition, method of producing the same, articles made therefrom, and method of making such articles, in accordance with any of the embodiments disclosed herein except that the crosslinked polyethylene composition formed through reaction of a mixture consisting essentially of (A) functionalized polyethlyene having vinyltrialkoxysilanol grafted functionalities; and (B) one or more hydroxyl-terminated silicones, wherein the crosslinked polyethylene comprises —C—C—Si—[O—Si(C)₂]ₘ—O—Si—C—C— crosslinkages; and (C) a small amount of catalyst.

### Test Methods

Test methods include the following:

Density was measured according to ASTM D 792, Method B, in isopropanol.

Melt indices (I₂ and I₂₁) were measured in accordance to ASTM D-1238 at 190° C. and at 2.16 kg and 21.6 kg load, respectively. Melt flow rate (I₁₀) is measured in accordance with ASTM-D 1238, Condition 190° C./10 kg.

The Gottfert or Rheoten melt strength, as indicated by viscosity, was measured using a capillary rheometer commercially available from Instron Corporation under the trade designation Instron Capillary Model 3211 coupled with a melt strength tester commercially available from Gottfert Inc. under the trade designation Goettfert Rheotens. A capillary rheometer is used to deliver a polymer melt through a die at a constant throughput rate. The melt strength tester is used to uniaxially stretch the molten polymer filament using nip rolls.

1. A crosslinked polyethylene composition formed through reaction of (A) functionalized polyethlyene having vinyltrialkoxysilanol grafted functionalities; and (B) hydroxyl-terminated silicone, wherein the crosslinked polyethylene comprises —C—C—Si—[O—Si(C)₂]ₘ—O—Si—C—C— crosslinkages; and (C) a small amount of catalyst

2. The crosslinked polyethylene according to claim 1, wherein the amount of hydroxyl-terminated silicone in the reaction is from 50 ppm to 20%, based on the amount of polyethylene in the reaction.

3. The crosslinked polyethylene according to claim 1 having a viscosity at 190° C. of at least 10⁷ Pa·s.

4. A process for preparing a crosslinked polyethylene composition comprising
providing a polyethylene having vinyltrialkoxysilanol grafted functionalities; and
mixing the polyethylene with 50 ppm to 20% hydroxyl-terminated silicone, based on the amount of polyethylene, to form a crosslinkable resin;
wherein the crosslinkable mixture is capable of forming —C—C—Si—[O—Si(C)₂]ₘ—O—Si—C—C— crosslinkages at a temperature less than 70° C.

5. An article of manufacture comprising the crosslinked polyethylene composition according to claim 1.

6. The article of manufacture according to claim 5, wherein the article is a pipe.

7. The pipe according to claim 6 having a wall thickness up to 20 cm.

8. The pipe according to claim 7, wherein the pipe is extruded.

9. A method of making a pipe comprising the step of extruding the crosslinked polyethylene composition of claim 1.

10. The crosslinked polyethylene composition according to claim 1, wherein the crosslinked polyethylene exhibits a viscosity at 190° C. of at least 10⁷ Pa
